(19) United States
(12) Patent Application Publication
(10) Pub. No.: US 2023/0403259 A1
(43) Pub. Date: Dec. 14, 2023

(54) REAL-TIME EVENT REPORTING FOR MANAGED COMPUTING DEVICES

(71) Applicant: Google LLC, Mountain View, CA (US)

(72) Inventors: Leonid Baraz, Bellevue, WA (US); Tracie Chan, Bellevue, WA (US); Zach Trudo, Seattle, WA (US); Brian Robert Malcolm, Seattle, WA (US); Yaohong Xi, Mountain View, CA (US); Mattias Nissler, Mountain View, CA (US); Jason Chun-Hong Wong, Charlesworth (GB); Stephen John Konig, Bellevue, WA (US)

(21) Appl. No.: 17/805,976

(22) Filed: Jun. 8, 2022

(51) Int. Cl. H04L 9/40; H04L 9/08

(52) U.S. Cl. CPC H04L 63/0428; H04L 9/0891

(57) ABSTRACT

According to an aspect, a method includes generating a computer event by a computing device of a management system, where the computer event includes information about a computer action initiated by activity on the computing device or information about a performance of the computing device. The method includes generating sequencing information for the computer event, encrypting the computer event, storing the encrypted computer event in a storage device of the computing device, and transmitting, over a network, an event request to a server, where the event request includes the encrypted computer event and the sequencing information.

### BACKGROUND

An administrator of an organization may manage computing devices associated with the organization. For example, management software may be installed on computing devices associated with the organization to monitor operations of the computer devices and/or protect the organization's data. Certain events generated by the computing devices may be collected and arranged in reports to be delivered to an administrator's computing device.

### SUMMARY

The management system provides a real-time reporting pipeline in which managed computing devices transmit events (e.g., information about login, logout, crash, performance data, etc.) to a server computer, and which are provided to an administrator's computing device so that the administrator can manage the enrolled devices. The events are encrypted and stored on a local file storage of a user's device and transmitted to the server along with sequencing information, which is used by the server to reduce (or eliminate) missing events (which may have been dropped due to network issues).

According to an aspect, a method includes generating a computer event by a computing device of a management system, where the computer event includes information about a computer action initiated by activity on the computing device or information about a performance of the computing device. The method includes generating sequencing information for the computer event, encrypting the computer event, storing the encrypted computer event in a storage device of the computing device, and transmitting, over a network, an event request to a server, where the event request includes the encrypted computer event and the sequencing information.

According to some aspects, the method may include receiving, over the network, an event response from the server, where the event response includes information that identifies whether the encrypted computer event is verified by the server. The method may include, in response to the encrypted computer event being verified by the server, deleting the encrypted computer event from the storage device. The sequencing information is configured to be used by the server to determine whether a previously-sent encrypted computer event has been verified at the server. The sequencing information may include a value representing a position of the encrypted computer event in a sequencing scheme. The position may be a relative location of a respective encrypted computer event in the sequencing scheme or with respect to another encrypted computer event. The sequencing scheme may determine the sequencing information for a particular computer event. For example, if the sequencing scheme is an ordered sequence of increasing values, the next value in the ordered sequence is determined as the sequencing information for the computer event. If the sequencing scheme is a digest, an output of a hash function is determined as the sequencing information for the computer event. In some examples, the sequencing information may represent the position of a previously-transmitted encrypted computer event. In some examples, the sequencing scheme is specific to the computing device. In some examples, the sequencing scheme is common to two or more computing devices. In some examples, the sequencing scheme is specific to a delivery priority level assigned to the computer event. In some examples, the encrypted computer event is a first encrypted computer event and the event request is a first event request and the method includes transmitting, in response to the first encrypted computer event not being verified by the server, a second event request to the server, the second event request including the first encrypted computer event and a second encrypted computer event. The method may include determining a delivery priority level based on a type of computer event of the encrypted computer event, in response to the delivery priority level being determined as a first delivery priority level, delaying transmission of the encrypted computer event for a period of time, and, in response to the delivery priority level being determined as a second delivery priority level, transmitting the encrypted computer event without delaying the transmission for the period of time.

According to an aspect, an apparatus includes at least one processor, and a non-transitory computer-readable medium storing executable instructions that when executed by the at least one processor cause the at least one processor to generate a computer event by a computing device of a management system, the computer event including information about a computer action initiated by activity on the computing device or information about a performance of the computing device, encrypt the computer event, store the encrypted computer event in a storage device of the computing device, transmit, over a network, an event request to a server, the event request including the encrypted computer event, and receive, over the network, an event response from the server, the event response including information that identifies whether the encrypted computer event is verified by the server.

According to some aspects, the computer event is encrypted using an encryption key, and where the event response includes an update to the encryption key. The encrypted computer event is configured to be decrypted using a decryption key, where the decryption key is not being stored on the computing device. The encrypted computer event is a first encrypted computer event and the event request includes the first encrypted computer event and a second encrypted computer event. In some examples, the executable instructions include instructions that when executed by the at least one processor cause the at least one processor to generate sequencing information for the computer event. The event request may also include the sequencing information. The sequencing information may include a value representing a position of the encrypted computer event in a sequencing scheme. In some examples, the sequencing scheme is specific to the computing device. In some examples, the sequencing scheme is common to two or more computing devices. In some examples, the sequencing scheme is specific to a delivery priority level assigned to the computer event. The sequencing information may include a value representing a previously-transmitted encrypted computer event in a sequencing scheme. The executable instructions include instructions that when executed by the at least one processor cause the at least one processor to, in response to the encrypted computer event being verified by the server, delete the encrypted computer event from the storage device. The executable instructions include instructions that when executed by the at least one processor cause the at least one processor to, in response to the encrypted computer event not being verified by the server, re-transmit the encrypted computer event in a subsequent event request.

According to an aspect, a non-transitory computer-readable medium storing executable instructions that when executed by at least one processor causes the at least one processor to execute operations. The operations include receiving, over a network, an event request from a computing device of a management system, the event request including information about a computer event and sequencing information for the computer event, the information about the computer event being encrypted, determining whether the computer event is verified based on the sequencing information, decrypting the information about the computer event using a decryption key, and transmitting, over the network, an event response to the computing device, the event response including information that identifies whether the computer event is verified.

According to some aspects, the computing device is a first computing device and the operations further include storing, in response to the computer event being verified, the computer event in an event database, and transmitting, over the network, information to render the computer event on a second computing device associated with an administrator of an organization that manages the first computing device. The sequencing information includes a value representing a previously-transmitted computer event. The operations may include verifying the computer event in response to determining that the value is a subsequent value with respect to sequencing information for the previously-transmitted computer event and storing, in response to the computer event being verified, the computer event in an event database. The operations may include verifying the computer event in response to the value matching a digest of the previously-transmitted computer event. The operations may include determining that the previously-transmitted computer event is stored in the event database. The operations may include, in response to the previously-transmitted computer event being determined as stored in the event database, determining that the computer event is a next event in a sequencing scheme. The operations may include determining that a value presenting a position of the computer event in the sequencing scheme is a next value from a value of a last verified computer event. The operations may include determining that the sequencing information corresponds to a hash of a last verified computer event. The event response may include information that identifies an update to an encryption key used to encrypt a future computer event.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a management system for managing events generated on computing devices associated with an organization according to an aspect.

FIG. 1B illustrates an example of a computing device enrolled in the management system according to an aspect.

FIG. 1C illustrates various examples of events generated by a computing device rolled in the management system according to another aspect.

FIG. 1D illustrates various examples of information included within an event according to an aspect.

FIG. 1E illustrates different types of events being associated with different delivery priority levels according to an aspect.

FIG. 1F illustrates an example of assigning sequencing information for events to be transmitted to a server according to an aspect.

FIG. 1G illustrates a server of the management system for processing, analyzing, and delivering events to a computing device associated with an administrator according to an aspect.

FIG. 2 illustrates an example user interface depicting a plurality of events that were generated by managed devices of an organization according to an aspect.

FIG. 3 illustrates an example user interface depicting a plurality of events that were generated by managed devices of an organization according to another aspect.

FIG. 4 illustrates a management system for managing events generated on computing devices associated with an organization according to an aspect.

FIG. 5 illustrates a flowchart depicting example operations of a management system according to an aspect.

FIG. 6 illustrates a flowchart depicting example operations of a management system according to another aspect.

FIG. 7 shows an example of a computer device and a mobile computer device according to an aspect.

### DETAILED DESCRIPTION

In some conventional management systems, when transmitting information over a network (e.g., the Internet), information can be lost (e.g., dropped) due to network outages, long latencies that cause a request/response event to time-out, and/or connection issues with the network, etc. When the dropped information includes information about events, this can result in delayed or inaccurate reporting and analysis of monitored devices. This disclosure relates to a management system that provides a technical solution of a real-time (or near real-time) reporting pipeline for events (e.g., computer events) generated by managed computing devices in a manner that can increase the reliability and integrity of transmitting event information over a network. Further, the management system may increase the speed at which the events can be reported to an administrator's computing device and/or increase the security of storing and managing the events.

For example, events generated on a user's device may be encrypted and stored on a local file storage of the user's device and transmitted to a server along with sequencing information (e.g., sequencing value(s), hash value(s), digest, etc.). An event may be transmitted to the server (e.g., immediately or relatively quickly) after the event is generated on the user's device. The server can decrypt the events and use the sequencing information to detect whether any previously-transmitted events are missing (which can occur due to network issues).

If the server determines that the event is the next event in a sequencing scheme, the server transmits an event response indicating that the event is verified, which causes the computing device to delete the event from the local file storage. When the event is verified, the server stores the verified first computer event in an event database, which is provided to an administrator's computing device.

Using the sequencing information, the server may determine that a particular event is not the next event in the sequencing scheme, which causes the server to transmit an event response indicating that the event is not verified. In response to the event response, the computing device may re-transmit that particular event along one or more previously-transmitted events (e.g., the missing event(s)) that are still stored in the local file storage. The use of the sequencing information may increase the integrity of the real-time reporting pipeline, where missing events can be quickly detected and re-sent.

In further detail, the management system may include a device management unit, executable by a server (e.g., one or more server computers), that receives, over a network, events (e.g., encrypted events) generated by one or more computing devices that are managed by an organization (e.g., enrolled in the management system). The events may include a wide variety of events generated by the computing device, which may represent log-in or log-out events, failed log-in events, crash events, application installation events, boot mode events, and/or telemetry events such as an event having information relating to the device's computer processing unit (CPU), memory, network, storage, battery, and/or operating system.

A managed computing device may include a client event manager, executable by an operating system of the managed computing device. In some examples, the client event manager is activated in response to the managed device being enrolled in the management system. As the user is operating the managed computing device, the client event manager may receive events generated by one or more event sources on the managed computing device. For example, if the user provides an incorrect password, an event may be generated and received by the client event manager. In response to the receipt of a generated event, the client event manager may encrypt the event (e.g., encrypt the information about the event) using an encryption key and store the event in a local storage of the managed device, which can increase the security of the data. The client event manager does not have access to a decryption key to decrypt the events, so that data about the events may not be obtained by any user of the managed device, including the user whose activity caused the generation of the event. That can prevent users of the device from tampering with event data, which can be important to the organization managing the device.

The client event manager may determine a timing of when to transmit an event, over the network, to the server based on a priority assigned to the type (or category) of a respective event. For example, the events may be higher priority events, lower priority events, and one or more priorities between the high and low priority events. The categories and priorities may widely vary and may depend upon the implementation of the management system with respect to particular organizations. Some examples of high priority events may include failed login attempts, log-in events, log-out events, crash events, and/or application installation events. Some examples of low priority events may include telemetry events such as events including information about the performance of the managed computing devices (e.g., memory, processing power, network latency, etc.).

The client event manager may send a high priority event to the server immediately (or relatively soon, e.g., within a few seconds, after the event is encrypted and stored in the local storage). For example, the client event manager may detect the type (or category) of the encrypted event stored in the local storage based on metadata associated with the encrypted event, and if the event is a high priority event (e.g., failed login attempt), the client event manager may transmit the encrypted event to the server. The client event manager may periodically send low priority events to the server, e.g., every few minutes, hours, days, etc. For example, at a time instance scheduled to send low priority events, the client event manager may detect that the local file storage includes one or more low priority events and then send those encrypted events to the server.

Further, the client event manager may generate and assign sequencing information for each event, where the device management unit at the server can use the sequencing information to detect whether one or more events are missing, manipulated, and/or for event deduplication. In some examples, the sequencing information is generated before the event is encrypted. In some examples, the sequencing information is generated after the event is encrypted. In some examples, the sequencing information may indicate a position of a respective encrypted event in a sequencing scheme. The position may be a relative location of a respective encrypted event in the sequencing scheme or with respect to another event.

In further details, the sequencing information may include a sequencing value associated with or assigned to a respective encrypted event. The sequencing value may be a single value or multiple values. For example, an event generated at a first time instance may be assigned a first sequence value, a subsequent event generated at a second time instance may be assigned a second sequence value, and another subsequent event generated at a third time instance may be assigned a third sequence value. A particular sequencing value may be determined according to the sequencing scheme. A sequencing scheme may represent any type of pattern, method, or formula for assigning a sequencing value to a computer event. In some examples, the sequencing scheme may be a pattern of increasing (or decreasing) values (e.g., “one”, followed by “two”, followed by “three”, etc.). In some examples, the sequencing scheme may be a digest (e.g., an event or message digest). For example, an output of a hash function may be used as the sequencing information for a particular computer event.

In some examples, the sequencing scheme may be specific to a delivery priority level associated with the computer event. In some examples, the sequence values are assigned to events having the same priority (e.g., the same priority level). For example, each level of priority may have its own sequencing scheme. In other words, each level of priority may define a separate sequencing pattern having a series of sequencing values that pertain to events assigned to a respective level of priority. In some implementations, the sequence value may be used to identify a previous event, e.g., an event received just prior to the event in a stream of events. In some implementations, the sequence value may be a digest or hash of the previous event.

If the event is a high priority event, the client event manager may immediately transmit, over the network, an event request to the server using an application programming interface (API). The event request includes the encrypted event and the sequencing formation associated with the encrypted event. If the event is a lower priority event, the client event manager may wait to transmit the encrypted event until the next scheduled time. In the meantime, other lower priority events may be encrypted and stored in the local storage. At the next scheduled time, the client event manager may transmit, over the network, an event request, where the event request includes multiple encrypted events and sequencing information for each of the encrypted events. In some examples, sequencing information is not generated for a particular event or a category of events, where the event request includes the encrypted event(s) without the sequencing information.

At the server, the device management unit may receive, via the API, the event requests. The device management unit may decrypt the encrypted event(s) using a decryption key stored at the server. In some examples, events that are received at the server may be decrypted and analyzed, thereby increasing the security of the management system. The device management unit may derive the sequencing information from the event request and determine whether to verify the event(s) using the sequencing information. In some examples, the verification operation is performed before the encrypted event is decrypted. In some examples, the verification operation is performed after the encrypted event is decrypted.

If the sequencing information of the last verified event indicates a first sequence value (e.g., “one”), the device management unit may verify the event if the sequencing information of a newly received (and decrypted) event has the next sequencing value in the sequencing scheme, e.g., a second sequencing value (e.g., “two”). If the sequencing information of the last verified event indicates the first sequencing value (e.g., “one”), the device management unit may not verify the event if the sequencing information of the newly received (and decrypted) event has a third sequencing value (e.g., “three”), which would indicate that the event having the second sequencing value (e.g., “two”) is missing. In some implementations, each priority level may have its own respective sequencing scheme. In some examples, the sequencing information is not used for one or more events (or categories of events), and the device management unit may decrypt the encrypted event(s), and, if the encrypted event(s) are successfully decrypted, these events may be considered verified and stored at the server.

In some examples, the device management unit may track the sequencing order of verified events and use that information to determine whether newly received (and decrypted) event(s) are in their expected position in the sequencing order. In some examples, the sequencing information of a respective event includes information about a previously-transmitted event. For example, the sequencing information may include a digest or hash of one or more previously-transmitted events (and the digest is included in the event request). The device management unit may derive the sequencing information (including the digest) from the event request to determine whether there are missing events.

In some examples, the event request, the encrypted event(s), and/or the sequencing information may identify the managed device that generated the corresponding events. In some examples, the sequencing scheme that is used to assign the sequencing values is specific to a particular managed device. For example, a first managed device may assign a sequencing value to a first event generated by the first managed device, another sequencing value to a second event generated by the first managed device, and so forth, where the actual sequencing value is determined by a sequencing scheme that is specific to the first managed device. If the sequencing scheme is a pattern of increasing values, the sequencing value may be “one”, followed by “two”, and so forth. A second managed device may assign a sequencing value to a first event generated by the second managed device, another sequencing value to a second event generated by the second managed device, and so forth, where the actual sequencing value is determined by a sequencing scheme that is specific to the second managed device.

In some examples, instead of using a sequencing scheme as a pattern of increasing values, the sequencing scheme may use digests as the sequencing information. Regardless of the specific type of sequencing scheme, in some examples, the assigned sequencing values are determined on a device-by-device basis. In some examples, two or more managed devices may share a common sequencing scheme, where the managed devices may communicate with each other to assign the next sequencing value in the common sequencing pattern. In some examples, two or more managed devices may share the digest of a previously-transmitted computer event.

In response to the event being verified, the device management unit at the server may store the verified event in an event database at the server. Also, in response to the event being verified, the device management unit may generate and send an event response to the client event manager on the managed device, where the event response indicates that the event has been verified. Then, in response to receipt of the event response, the client event manager may delete the event (e.g., the encrypted event) from the local storage device. Also, the device management unit may provide the events (e.g., verified events), over the network, to a computing device associated with the administrator.

In response to the event not being verified, the device management unit does not store the event in the event database at the server. In some examples, in response to the event not being verified, the device management unit may generate and send a notification to the administrator's computing device. Also, in response to the event not being verified, the device management unit may generate and send an event response to the client event manager on the managed device, where the event response indicates that the event has not been verified. If the client event manager does not receive an indication that the event has been verified, the event is not deleted from the local storage device, and the client event manager may resend the event in a subsequent event request. These and other features are further explained with reference to the figures.

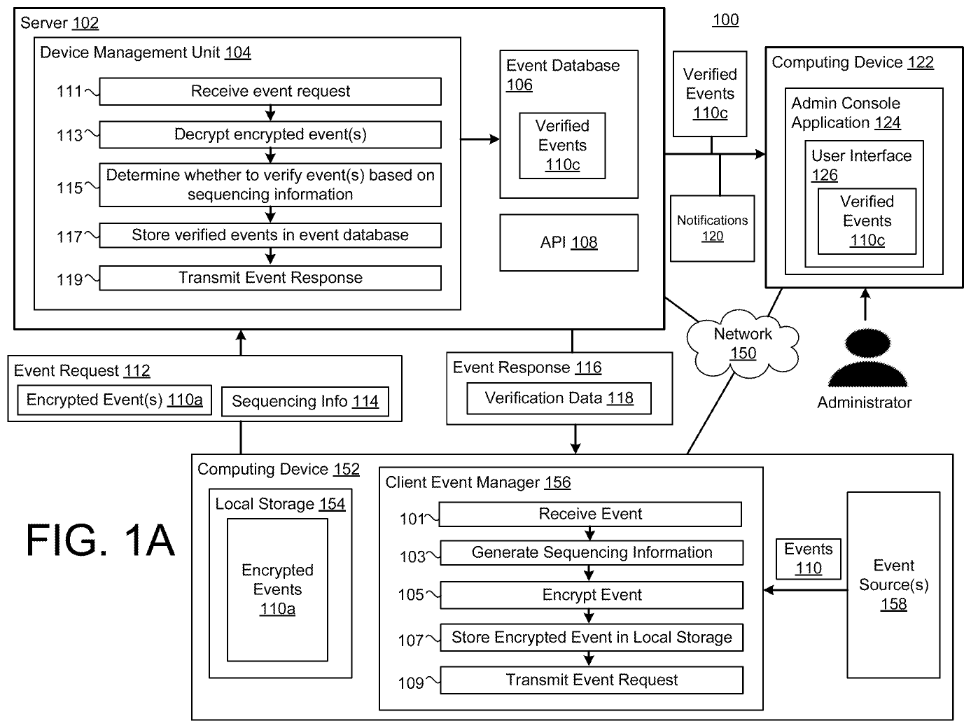

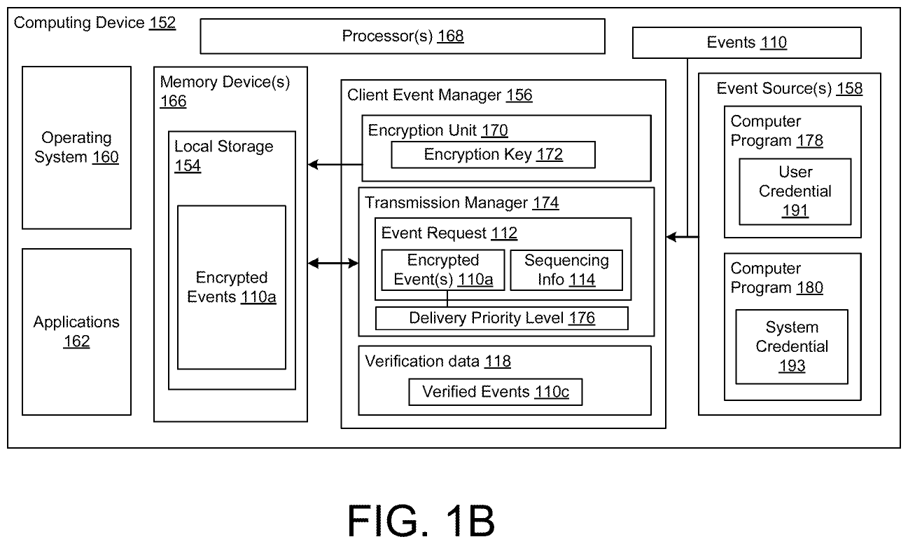

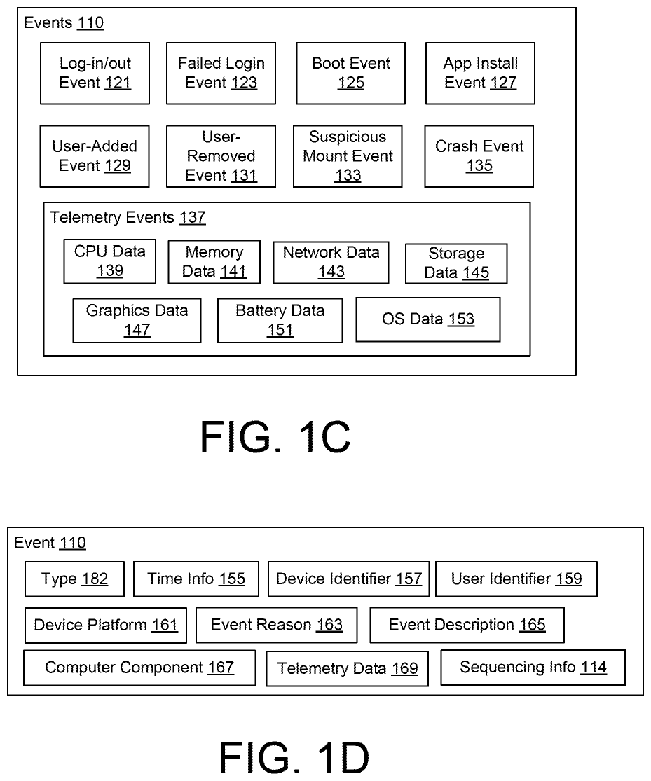

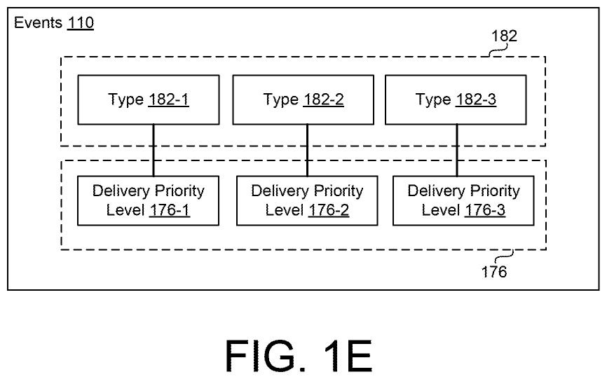

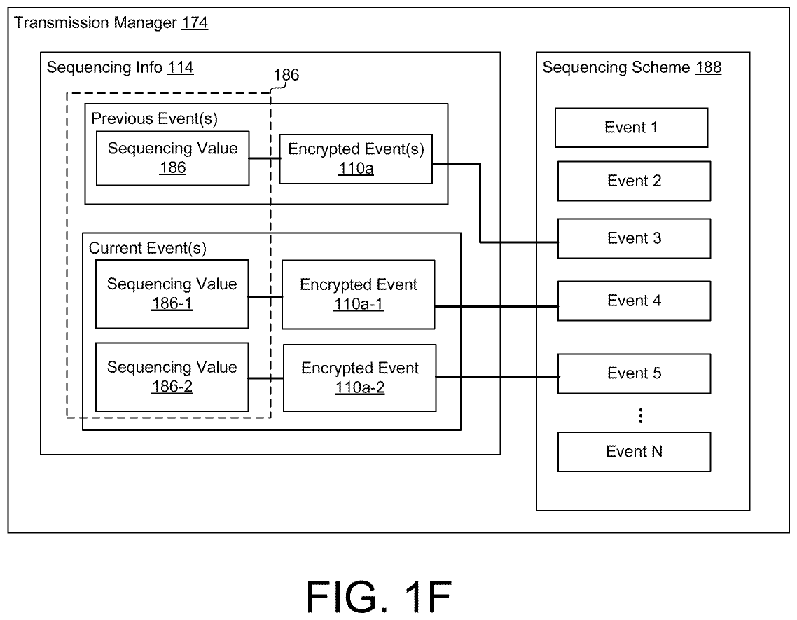

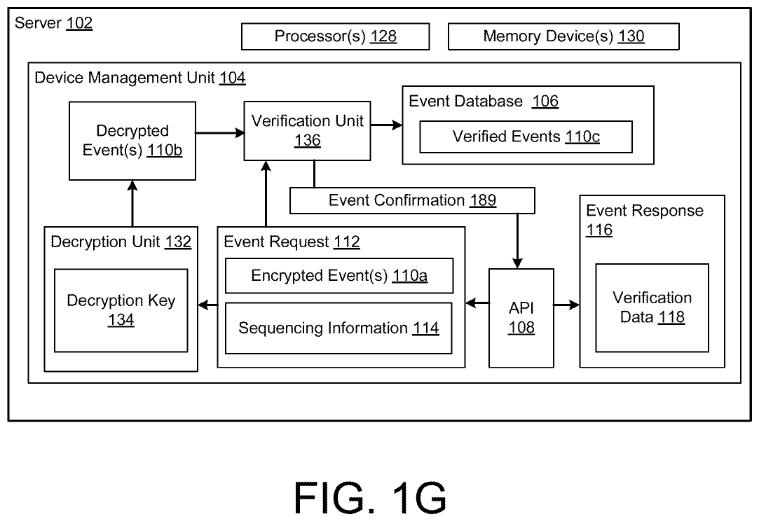

FIGS. 1A through 1G illustrate a management system 100 for managing events 110 generated by computing devices 152 associated with an organization (one of which is illustrated in FIG. 1A). The management system 100 may deliver verified events 110c, over a network 150, to a computer device 122 associated with an administrator (e.g., IT administrator). The management system 100 is configured to implement a reporting pipeline (e.g., real-time, or near-real time) for events 110 generated by managed computing devices 152 in a manner that can increase the speed at which events 110 can be reported to an administrator's computing device 122, increase the security of storing and managing events 110, and/or increase the reliability and integrity of transmitting event information over a network 150. For example, the management system 100 may reduce (or eliminate) events 110 that are missing/dropped (e.g., due to network issues) and the encryption/decryption mechanism discussed herein may increase the security of the management system.

The management system 100 may include a device management unit 104, executable by a server 102, that receives, over the network 150, events 110 (e.g., encrypted events 110a) generated by one or more computing devices (e.g., computing device 152) that are managed by an organization (e.g., enrolled in the management system 100). The device management unit 104 includes an application programming interface (API) 108 configured to receive the events 110 from the computing device 152. The device management unit 104 may decrypt, verify, and store the events 110 in an event database 106 at the server computer. The device management unit 104 may provide verified events 110c from the event database 106, over the network 150, to a computing device 122 associated with an administrator of an organization.

The computing device 122 includes an administrative console application 124 that renders a user interface 126 to enable an administrator to view the verified events 110c generated by the computing devices 152 enrolled in the management system 100. In some examples, the administrative console application 124 is a web application executable (at least in part) by a web browser to render the user interface 126. In some examples, the administrative console application 124 is a native application installed and executed by an operating system of the computing device 122.

The computing device 152 may include a client event manager 156. As a user is using the computing device 152, the client event manager 156 may collect and transmit events 110 (e.g., encrypted events 110a) to the device management unit 104 at the server 102. The client event manager 156 may be activated when the computing device 152 is enrolled in the management system 100. In some examples, the administrator may use the computing device 152 to activate the client event manager 156. In some examples, the administrator may use their computing device 122 to enroll the computing device 152, which causes the device management unit 104 to transmit information to the computing device 152 to activate the client event manager 156. When the client event manager 156 is not activated, events 110 are not collected by the device management unit 104 and reported to the administrator's computing device 122.

The operations of the client event manager 156 and the device management unit 104 are generally discussed with reference to FIG. 1A, and the details of those operations are further discussed with reference to FIGS. 1B through 1G. Referring to FIG. 1A, in operation 101, the client event manager 156 may receive an event 110 from an event source 158. In operation 103, the client event manager 156 may generate sequencing information 114. The sequencing information 114 is used by the device management unit 104 at the server to determine whether one or more previously-transmitted encrypted events 110a are missing and/or manipulated. The sequencing information 114 is further explained later in the disclosure but may include a sequencing value 186 that indicates a position of an event 110 in a sequencing scheme 188. The sequencing value 186 is therefore unique within the sequencing scheme 188. In some examples, a sequencing value 186 is a digest of a previously-generated encrypted event 110a. The position may be a relative location of a respective event 110 in the sequencing scheme 188 or with respect to another event 110. In some examples, sequencing information 114 is not generated for one or more events 110 or categories of events 110.

In operation 105, the client event manager 156 may encrypt the event 110, thereby obtaining an encrypted event 110a. In some examples, the encrypted event 110a includes the sequencing information 114. In some examples, the sequencing information 114 is encrypted. In some examples, the sequencing information 114 is not encrypted. In some examples, the sequencing information 114 is separate from the encrypted event 110a, but the sequencing information 114 and the encrypted event 110a are included as part of the event request 112. In operation 107, the client event manager 156 may store the encrypted event 110a (and, in some examples, the sequencing information 114 if the sequencing information 114 is not part of the encrypted event 110a) in a local storage 154 of the computing device 152. The client event manager 156 does not have access to a decryption key (e.g., a decryption key 134 of FIG. 1G) to decrypt the encrypted events 110a, where data about the events 110 may not be obtained by any user of the computing device 152, including the user whose activity caused the generation of the event 110.

For example, the computing device 152 may be associated with multiple users, e.g., a first user and a second user. The first user may log into the computing device 152 to use the computing device 152 under the first user's authentication credential or the second user may log into the computing device 152 to use the computing device 152 under the second user's authentication credential. The local storage 154 may be a device storage device that is common to the first user and the second user (e.g., information can be stored in the local storage 154 under the first user's authentication credential or the second user's authentication credential). The first user's activity on the computing device 152 may cause generation of an event 110, and the encrypted event 110a is stored in the local storage 154. Since the decryption key 134 is not stored locally on the computing device 152, the first user or the second user would not be able to obtain information about the event 110.

In operation 109, the client event manager 156 may transmit an event request 112, where event request 112 may include one or more encrypted events 110a and the sequencing information 114. In some examples, the sequencing information 114 is included within one or more encrypted events 110a (or included within each encrypted event 110a). In some examples, the event request 112 and/or the encrypted event(s) 110a do not include the sequencing information 114. Although the operations (e.g., 101, 103, 105, 107, 109) are depicted in sequential order, the client event manager 156 may execute the operations in a different order, or in a parallel or overlapping fashion. For example, operation 103 may be performed after operation 105 or after operation 107.

At the server 102, the device management unit 104 may perform operations to receive and process the event requests 112 received from the computing device 152. In operation 111, the device management unit 104 receives an event request 112 via the API 108. In operation 113, the device management unit 104 may decrypt encrypted event(s) 110a identified by the event request 112. In operation 113, the device management unit 104 may determine whether to verify the events 110 based on the sequencing information 114. For example, the device management unit 104 may determine whether a sequencing value 186 of an event 110 received at the server 102 is the next position (e.g., next value) in the sequencing scheme 188 associated with a specific computing device 152 or multiple computing devices 152. If the sequencing value 186 is the next position, the device management unit 104 may verify the event 110. The sequencing value 186 not being the next position may indicate that a previously-sent event 110 has been lost (or not received at the server 102). In some examples, an encrypted event 110a is not associated with sequencing information 114, and the device management unit 104 may verify the event 110 in response to the encrypted event 110a being successfully decrypted. In operation 117, the device management unit 104 may store verified events 110c in the event database 106. In operation 119, the device management unit 104 may transmit an event response 116 to the client event manager 156 via the API 108. The event response 116 may include verification data 118 that identifies the verified events 110c.

The client event manager 156 may use the verification data 118 to update the local storage 154. For example, the client event manager 156 may delete encrypted events 110a from the local storage 154 that have been identified in the verification data 118. If a previously-sent encrypted event 110a has not been verified, the client event manager 156 does not delete the previously-sent encrypted event 110a from the local storage 154 and may re-transmit this encrypted event 110a in another event request 112. In this manner, the integrity and reliability of the events 110 are maintained, thereby reducing (or eliminating) lost events.

FIG. 1B illustrates an example of a computing device 152 in further detail. The computing device 152 may be any type of computing device that includes one or more processors 168, one or more memory devices 166, and an operating system 160 configured to execute (or assist with executing) one or more applications 162. In some examples, the operating system 160 is considered an application 162. In some examples, the computing device 152 is a laptop or desktop computer. In some examples, the computing device 152 is a tablet computer. In some examples, the computing device 152 is a smartphone. In some examples, the computing device 152 is a wearable device.

The operating system 160 is a system software that manages computer hardware, software resources, and provides common services for computing programs. In some examples, the operating system 160 is an operating system designed for a larger display such as a laptop or desktop (e.g., sometimes referred to as a desktop operating system). In some examples, the operating system 160 is an operating system for a smaller display such as a tablet or a smartphone (e.g., sometimes referred to as a mobile operating system).

The client event manager 156 may be executable by the operating system 160. In some examples, the client event manager 156 is executable by a browser application. The client event manager 156 may be activated when the computing device 152 is enrolled in (e.g., registered with) the management system 100. In some examples, the client event manager 156 is deactivated when the computing device 152 is not enrolled in the management system 100.

The client event manager 156 may receive an event 110 from an event source 158. An event 110 may be a computer-generated event about the status, performance, and/or activity on the computing device 152. An event 110 includes or represents information about a computer action initiated by user activity on the computing device 152 or information about the performance of the computing device 152. The events 110 may be generated by one or more event sources 158 on the computing device 152. An event source 158 may be a computer program of the computing device 152.

In some examples, an event source 158 includes a computer program 178 that is executed under a user credential 191 of the user of the computing device 152, for example, a browser or other program associated with a user profile. In some examples, a user credential 191 is an authentication token (e.g., a key, certificate, login/password, etc.) that is bound to a particular user. In some examples, an event source 158 includes a computer program 180 that is executed under a system credential 193. In some examples, a system credential 193 includes one or more properties of a process that is not bound to a particular user. In some examples, the computer program 180 is a background process that is not under the direct control of a particular user. In some examples, the computer program 180 is a daemon. In some examples, the computer program 180 is a window service. In some examples, the computer program 180 is a Unix-based process. The client event manager 156 may be communicatively coupled to one or more event sources 158 and may receive an event 110 when a respective event source 158 generates an event 110.

The events 110 may include a wide variety of events. Referring to FIG. 1C, the events 110 may include a log-in or log-off event 121 such as when the user supplies their login/password (or other authentication credential) and successfully logs into the computing device 152 or when the user logs off the computing device 152. For example, when the user successfully logs into the computing device 152, the client event manager 156 may receive a log-in event from the event source 158, where the log-in event includes details about the user logging-in (e.g., name of event, time, device and/or user identifiers, etc.). Similarly, when the user logs out of the computing device 152, the client event manager 156 may receive a log-out event from the event source 158, where the log-out event includes details about the user logging-off.

The events 110 may include a failed login event 123 such as when the user supplies an incorrect password. The events 110 may include a boot event 125 while starting or operating the computing device 152 such as any type of boot mode that a user can enter, e.g., safe mode, safe mode with network, safe mode with command, boot logging, video graphics array (VGA) mode, debugging mode, etc. The events 110 may include an application installation event 127 such as when the user requests installation of an application 162 on the computing device 152 or installs a new application 162 on the computing device 152 (which may include web applications, extensions, or native applications).

The events 110 may include a user-added event 129 such as when a user (e.g., user account) is added to the computing device 152. The events 110 may include a user-removed event 131 such as when a user (e.g., a user account) is removed or deleted from the computing device 152. The events 110 may include a suspicious mount event 133 such as when an external device is connected to the computing device 152 but is not recognized by the computing device 152. The events 110 may include a crash event 135 such as when one or more programs of the computing device 152 terminate (e.g., suddenly reboots or shuts down).

The events 110 may include telemetry events 137 about the performance of the computing device 152. For example, a telemetry event 137 may include CPU data 139, memory data 141, network data 143, storage data 145, graphics data 147, battery data 151, and/or operating system data 153. The CPU data 139 may indicate the processing power used (or available) by the computing device 152 at a particular instance or over a period of time. The memory data 141 may include the amount of memory (e.g., RAM memory) used (or available) by the computing device 152 at a particular instance or over a period of time. The network data 143 may indicate information about the network 150 (e.g., strength, latency) at a particular instance or over a period of time. The storage data 145 may indicate the amount of storage (e.g., long-term storage such as hard drives and solid state drives) used or available at a particular instance or over a period of time. The battery data 151 may indicate information about the status, usage, or performance of the battery of the computing device 152. The operating system data 153 may include information about the version of the operating system of the computing device 152.

The client event manager 156 may periodically receive a telemetry event 137 about the performance of the computing device 152. In some examples, the client event manager 156 may receive a telemetry event 137 in response to one of the types of information exceeding a threshold level (e.g., the CPU or memory usage being greater than a threshold amount). The client event manager 156 may receive the different types of events 110 from one or more event sources 158. In some examples, the client event manager 156 may receive the events 110 from multiple event sources 158.

A particular event 110 may include or represent information about a computer action initiated by activity (e.g., user activity and/or operating system activity) on the computing device 152 or information about the performance of the computing device 152. For example, as shown in FIG. 1D, the event 110 may identify a type 182 of event 110. The type 182 may be a name or category of the event 110. The event 110 may include time information 155 that identifies a date and/or time in which the event 110 was generated. The event 110 may include a device identifier 157 that identifies the computing device 152 that generated the event 110. The event 110 may include a user identifier 159 associated with the computing device 152. The event 110 may identify a device platform 161 such as the type (and version) of operating system 160 associated with the computing device 152. The event 110 may include an event reason 163 that includes a description on the reason on why the event 110 was generated. The event 110 may include an event description 165 that provides further details about the event 110. The event 110 may identify a computer component 167 (e.g., the event source 158) that generated the event 110. If the event 110 relates to a telemetry event 137, the event 110 may include telemetry data 169, e.g., one or more of the data described with reference to FIG. 1B. In some examples, the event 110 includes the sequencing information 114, which is further described below.

Referring back to FIG. 1B, the client event manager 156 includes an encryption unit 170 configured to encrypt an event 110 generated by a respective event source 158. For example, the encryption unit 170 may use an encryption key 172 to encrypt the event 110 (thereby producing the encrypted event 110a), and the encryption unit 170 may store the encrypted event 110a in the local storage 154. The encryption key 172 may encrypt the event 110 but is not able to decrypt the encrypted events 110a in the local storage 154. The client event manager 156 includes a transmission manager 174 configured to communicate with the local storage 154 to obtain and send encrypted events 110a to the device management unit 104 at the server 102.

The transmission manager 174 may determine a timing of when to transmit an encrypted event 110a, over the network 150, based on a delivery priority level 176 assigned a type 182 of a respective event 110. For example, the events 110 may be higher priority events, lower priority events, and one or more priorities between the high and low priority events. The categories and priorities may widely vary and may depend upon the implementation of the management system 100 with respect to particular organizations. Some examples of high priority events 110 may include log-in/out events 121, failed login events 123, crash events 135, and/or application installation events 127. Some examples of low priority events 110 may include telemetry events 137.

Referring to FIG. 1E, the management system 100 may determine and/or assign different delivery priority levels 176 for various types 182 of events 110. For example, as shown in FIG. 1E, the management system 100 may define a delivery priority level 176-1, a delivery priority level 176-2, and a delivery priority level 176-3. Although three delivery priority levels 176 are depicted in FIG. 1E, the management system 100 may define any number of delivery priority levels such as two, or any number greater than three. In some examples, the delivery priority level 176-1 may represent the highest level of priority, where if a type 182-1 of event 110 is assigned to the delivery priority level 176-1, the transmission manager 174 may determine to transmit the event 110 immediately. The type 182-1 may be log-in/out events 121, failed login events 123, crash events 135, and/or application installation events 127.

In some examples, the delivery priority level 176-3 may present the lowest level of priority, where if a type 182-3 of event 110 is assigned to the delivery priority level 176-3, the transmission manager 174 may determine to transmit the event 110 at the lowest level, e.g., not transmit the event 110 or wait the longest period of time before transmitting the event 110. The type 182-3 may be telemetry events 137. The delivery priority level 176-2 may represent a level of delivery between the delivery priority level 176-1 and the delivery priority level 176-3, where a type 182-2 of event 110 assigned to the delivery priority level 176-2 is delivered at a later time than the delivery priority level 176-1 but faster than the delivery priority level 176-3. The type 182-2 may be boot events 125 or other types 182 of events 110.

The transmission manager 174 may determine the delivery priority level 176 based on the type 182 of the event 110. In some examples, the transmission manager 174 may determine the timing of when to send the event 110 to the server 102 before the event 110 is encrypted. If the delivery priority level 176 is the delivery priority level 176-1, the transmission manager 174 may determine to transmit the event 110 without waiting. If the delivery priority level 176 is the delivery priority level 176-2 or the delivery priority level 176-3, the transmission manager 174 may determine to wait a period of time to transmit the event 110.

In other words, the transmission manager 174 may send a high priority event 110 (e.g., being assigned delivery priority level 176-1) to the server 102 immediately (or relatively soon after the event 110 is encrypted and stored in the local storage 154, e.g., within two seconds). In some examples, the transmission manager 174 may detect the type 182 of the encrypted event 110a stored in the local storage 154 based on metadata associated with the encrypted event 110a, and if the event 110 is a high priority event (e.g., failed login event 123), the transmission manager 174 may transmit the encrypted event 110a to the server 102. The transmission manager 174 may periodically send low priority events 110 (e.g., having delivery priority level 176-2 or delivery priority level 176-3) to the server 102, e.g., every few minutes, hours, days, etc. For example, at a time instance scheduled to send low priority events, the transmission manager 174 may detect that the local storage 154 includes one or more low priority events 110 and then send those encrypted events 110a to the server 102.

In some examples, before transmitting to the server 102, the transmission manager 174 may generate and assign sequencing information 114 for each event 110 (or each encrypted event 110a), where the device management unit 104 at the server 102 can use the sequencing information 114 to detect whether one or more events 110 are missing or manipulated. In some examples, the client event manager 156 may determine, compute, or assign the sequencing information 114 for each event 110 before the event 110 is encrypted by the encryption unit 170.

Referring to FIG. 1F, the transmission manager 174 may obtain encrypted event 110a-1 and encrypted event 110a-2 from the local storage 154. For example, the encrypted event 110a-1 and the encrypted event 110a-2 may have the same delivery priority level 176, which indicates to transmit every certain period of time (e.g., every X minutes). The encrypted event 110a-1 may have the delivery priority level 176-2, and the encrypted event 110a-2 may have the delivery priority level 176-2. If the encrypted event 110a-2 has the delivery priority level 176-1, the encrypted event 110a-2 may be assigned a sequencing value 186 according to a sequencing scheme 188 associated with the delivery priority level 176-1. The transmission manager 174 may determine to send the encrypted event 110a-1 and the encrypted event 110a-2 via an event request 112. The transmission manager 174 may determine the sequencing information 114 for the encrypted events 110a included within the event request 112.

Referring to FIG. 1F, the encrypted event 110a-1 may have a sequencing value 186-1, and the encrypted event 110a-2 may have a sequencing value 186-2. The sequencing value 186-2 may be the next position (after the sequencing value 186-1) in the sequencing scheme 188. The sequencing information 114 may indicate a position of a respective encrypted event 110a in a sequencing scheme 188. For example, the position may denote a relative location of a particular encrypted event 110a with respect to other encrypted events 110a. In other words, the sequencing scheme 188 may be an ordered list (e.g., ordered list of sequencing values 186) and the sequencing information 114 of a particular encrypted event 110a indicates the position of the particular encrypted event 110a in the ordered list. In some examples, the sequencing scheme 188 can be an implied ordered list, e.g., in the sense that a blockchain is an ordered list, but the order is implied by the hashes (e.g., link is to the node that has content that, when hashed, matches the hash of the current node).

A particular sequencing value 186 may be determined according to the sequencing scheme 188. In some examples, a sequencing value 186 is a numerical value (or multiple numerical values). In some examples, a sequencing value 186 is a character value (or multiple character values). In some examples, a sequencing value 186 is a combination of numerical and character values. A sequencing scheme 188 may represent any type of pattern, method, or formula for assigning a sequencing value 186 to a computer event 110. In some examples, the sequencing scheme 188 may be a pattern of increasing (or decreasing) values (e.g., “one”, followed by “two”, followed by “three”, etc.). In some examples, the sequencing scheme 188 may be a digest (e.g., an event or message digest). For example, an output of a hash function may be used as the sequencing information 114 for a particular computer event 110. For example, the transmission manager 174 may define a hash function (e.g., cryptographic hash function). The output (e.g., hash value(s) of the hash function may be the sequencing value 186 associated with the computer event 110. In some examples, the hash function is inputted with information (or a portion thereof) of a current event 110, and the output of the hash function may be the sequencing value 186 of the current event 110. In some examples, the hash function is inputted with information (or a portion thereof) of a previously-transmitted event 110, and the output of the hash function may be the sequencing value 186 of the current event 110. In some examples, the sequencing scheme 188 is associated with a stream of events 110. In some examples, the sequencing scheme 188 is an ordered (and/or sequential) list of events 110.

As shown in FIG. 1F, the sequencing scheme 188 is associated with event 1, event 2, event 3, event 4, event 5 through event N. Events 1, 2, 3, and 4 may represent events 110 that have been previously-transmitted. Each event 110 has a sequencing value 186 that represents its respective position in the sequencing scheme 188. For simplicity, the sequencing value 186 for Event 1 is “one”, the sequencing value 186 for Event 2 is “two”, the sequencing value 186 for Event 3 is “three” and so forth. However, the sequencing value 186 may be any type of value that indicates a position of an event 110 within a sequencing scheme 188. The transmission manager 174 may determine that the next sequencing value 186 in the sequencing scheme 188, assign the encrypted event 110a-1 to the next sequencing value 186 (e.g., “four”), and then assign the encrypted event 110a-2 to the subsequent sequencing value 186 (e.g., “five).

In some examples, the sequencing scheme 188 that is used to assign the sequencing values 186 is specific to a particular computing device 152. For example, a first computing device may assign a sequencing value 186 to a first event generated by the first computing device, another sequencing value 186 to a second event generated by the first computing device, and so forth, where the actual sequencing value 186 is determined by the sequencing scheme 188 that is specific to the first computing device. If the sequencing scheme 188 is a pattern of increasing values, the sequencing value 186 may be “one”, followed by “two”, and so forth. A second computing device may assign a sequencing value 186 to a first event generated by the second computing device, another sequencing value 186 to a second event generated by the second computing device, and so forth, where the actual sequencing value 186 is determined by a sequencing scheme 188 that is specific to the second computing device. As such, in some examples, the assigned sequencing values 186 are determined on a device-by-device basis. For example, the first computing device may be associated with a first sequencing scheme and the second computing device may be associated with a second sequencing scheme that is separate from the first sequencing scheme.

In some examples, two or more computing devices 152 may share a common sequencing scheme 188. For example, the first computing device and the second computing device may assign sequencing values 186 to their generated events 110 according to a common sequencing scheme 188. For example, the first computing device may generate a first event at a first time instance and a second event at a second (later) time instance, and the second computing device may generate a third event at a third (later) time instance and a fourth event at a fourth (later) time instance. The first event may be assigned a sequencing value 186 of one, the second event may be assigned a sequencing value 186 of two, the third event may be assigned a sequencing value 186 of three, and the fourth event may be assigned a sequencing value 186 of four. Although increasing integers are used in this example, it is noted that the sequencing values 186 may encompass any type of value that would indicate a next position or order in the sequencing scheme 188 (or a digest of a current or previously-transmitted event 110). In some examples, computing devices 152 that share the common sequencing scheme 188 may communicate with each other to assign the next sequencing value 186 in the common sequencing scheme 188.

The transmission manager 174 generates the event request 112 to include the encrypted event 110a-1, the encrypted event 110a-2, and the sequencing information 114 (e.g., sequencing value 186-1 (e.g., “four”), sequencing value 186-2 (e.g., “five”)) for the encrypted event 110a-1 and the encrypted event 110a-2. In some examples, the sequencing information 114 also includes a sequencing value 186 for one or more previously-transmitted encrypted events 110a (which may also be referred to as a digest). For example, the sequencing information 114 may include the sequencing value 186 for Event 3. In some examples, the sequencing information 114 does not include the sequencing information 114 for previously-transmitted encrypted events 110a (e.g., does not include a digest).

As indicated above, the sequencing information 114 may depend on the delivery priority level 176. For example, events 110 having the same delivery priority level 176 are assigned a next sequencing value 186 in the sequencing scheme 188. For example, if the next event (e.g., Event 6) has the delivery priority level 176-2, the transmission manager 174 may assign the next sequencing value 186 in the sequencing scheme 188 (e.g., “six”). However, if the next event (e.g., Event 6) has a different delivery priority level 176 (e.g., delivery priority level 176-1), the transmission manager 174 may assign Event 6 to the next sequence in the sequencing scheme 188 for the delivery priority level 176-1. In other words, an event 110 having delivery priority level 176-1 may be assigned a next sequencing value 186 in a first sequencing scheme, an event 110 having delivery priority level 176-2 may be assigned a next sequencing value 186 in a second sequencing scheme, and an event 110 having delivery priority level 176-3 may be assigned a next sequencing value 186 in a third sequencing scheme, where the first through third sequencing schemes correspond to separate sequencing patterns (which may be the same or different).

FIG. 1G illustrates an example of the device management unit 104 at the server 102. The server 102 may include one or more processors 128 and one or more memory devices 130. The server 102 may be computing devices that take the form of a number of different devices, for example a standard server, a group of such servers, or a rack server system. In some examples, the server 102 may be a single system sharing components such as processors and memories. In some examples, the server 102 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. Network 150 may further include any number of hardwired and/or wireless connections.

At the server 102, the device management unit 104 may receive, via the API 108, the event request 112. The event request 112 includes one or more encrypted events 110a and the sequencing information 114. In some examples, the event request 112 includes one or more encrypted events 110a but without sequencing information 114. The device management unit 104 includes a decryption unit 132 configured to decrypt the encrypted event(s) 110a using a decryption key 134. The decryption key 134 is not stored at the computing device 152. The decryption key 134 is stored at the device management unit 104.

The device management unit 104 includes a verification unit 136. The verification unit 136 may derive the sequencing information 114 from the event request 112 and determine whether to verify the decrypted event(s) 110b using the sequencing information 114. For example, if the sequencing information 114 of the last verified event 110c indicates a first sequence value, the verification unit 136 may verify the decrypted event 110b if the sequencing information 114 of a newly received (and decrypted) event 110b has the next sequencing value 186 (e.g., a second sequencing value). If the sequencing information 114 of the last verified event 110c indicates the first sequencing value, the verification unit 136 may not verify the decrypted event 110b if the sequencing information 114 of the newly received (and decrypted) event 110b has a third sequencing value, which would indicate that an event 110 having the second sequencing value has not been received.

In some examples, the verification unit 136 tracks the sequencing order of verified events 110c and uses that information to determine whether newly received (and decrypted) event(s) 110b are in their expected position in the sequencing order. In some examples, the sequencing information 114 of a respective event 110 includes information about a previously-sent event 110. For example, the sequencing information 114 may include a digest of one or more previously sent events 110 and the verification unit 136 uses the digest to determine whether there are missing events. For example, the sequencing information 114 may include the sequencing value 186 (e.g., Event 3) for a previously-sent encrypted event 110a. However, if the received events are Events 5 and 6, the verification unit 136 may determine that Event 4 is missing and then not verify Events 5 and 6. In some examples, the verification unit 136 may verify an event 110 if the encrypted event 110a is successfully decrypted (e.g., without using the sequencing information 114).

In response to the decrypted event 110b being verified, the verification unit 136 may store the verified event 110c in an event database 106 at the server 102. Also, in response to the event 110c being verified, the verification unit 136 may send an event confirmation 189 to the API 108. The API 108 may generate and send an event response 116 that includes verification data 118 that identifies one or more verified events 110c. Referring back to FIGS. 1A and 1B, in response to receipt of the event response 116, the client event manager 156 may delete the encrypted event 110a from the local storage 154. Also, the device management unit 104 may provide the events (e.g., verified events 110c) to a computing device 122 associated with the administrator.

In response to the event not being verified, the device management unit 104 does not store the event 110 in the event database 106 at the server 102. In some examples, in response to the event 110 not being verified, the device management unit 104 may generate and send a notification 120 to the administrator's computing device 122. Also, in response to the event 110 not being verified, the device management unit 104 may generate and send an event response 116 to the client event manager 156, where the event response 116 indicates that the event 110 has not been verified. If the client event manager 156 does not receive an indication that the event 110 has been verified, the encrypted event 110a is not deleted from the local storage 154, and the client event manager 156 may resend the event 110 in a subsequent event request 112.

In some examples, the device management unit 104 may use the event responses 116 to send updates to the encryption key 172. For example, the encryption key 172 may be periodically changed. In some examples, an event response 116 may include a new encryption key. In some examples, the event response 116 may include information for the client event manager 156 to generate a new encryption key.

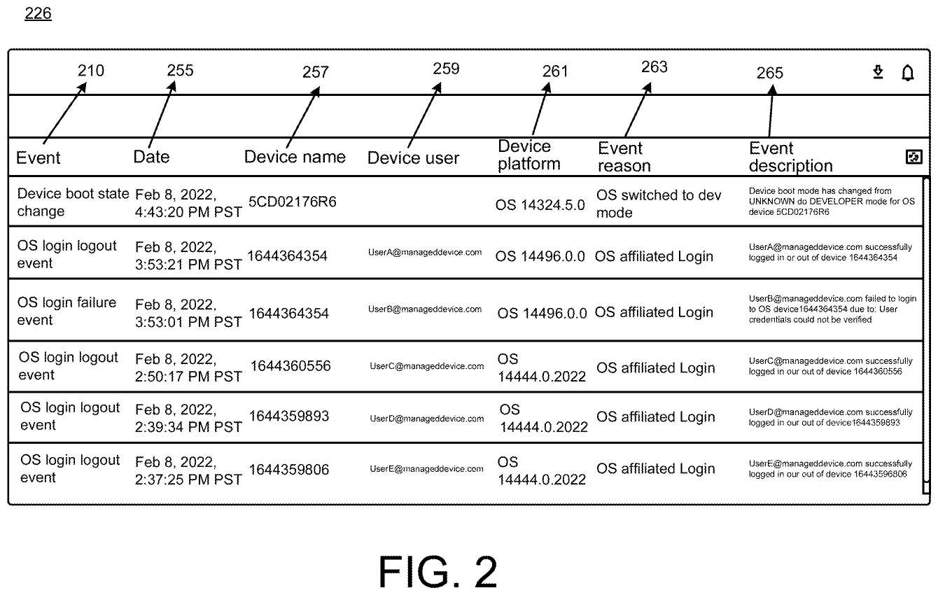

FIG. 2 illustrates an example of a user interface 226 of a computing device associated with an administrator. The user interface 226 may be an example of the user interface 126 of FIG. 1A. The user interface 226 may depict an audit log having a plurality of events 210 (e.g., each row item indicates a separate event 210). For each event 210, the user interface 226 may provide a type of event, date information 255, a device identifier 257, a user identifier 259, a device platform 261, an event reason 263, and an event description 265.

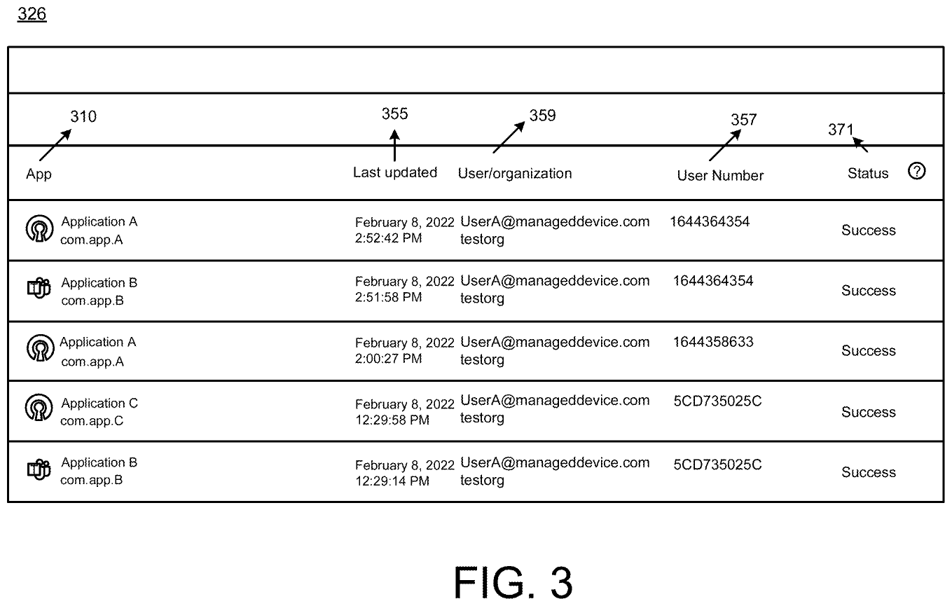

FIG. 3 illustrates an example of a user interface 326 of a computing device associated with an administrator. The user interface 326 may be an example of the user interface 126 of FIG. 1A. The user interface 326 depicts an application installation request having a plurality of events 310 relating to applications installed on computing devices associated with an organization. For each event 310, the user interface 326 identifies which application, time information 355 (e.g., last updated), user and/or organization identifier 359, device identifier 357, and/or a status 371 of installation.

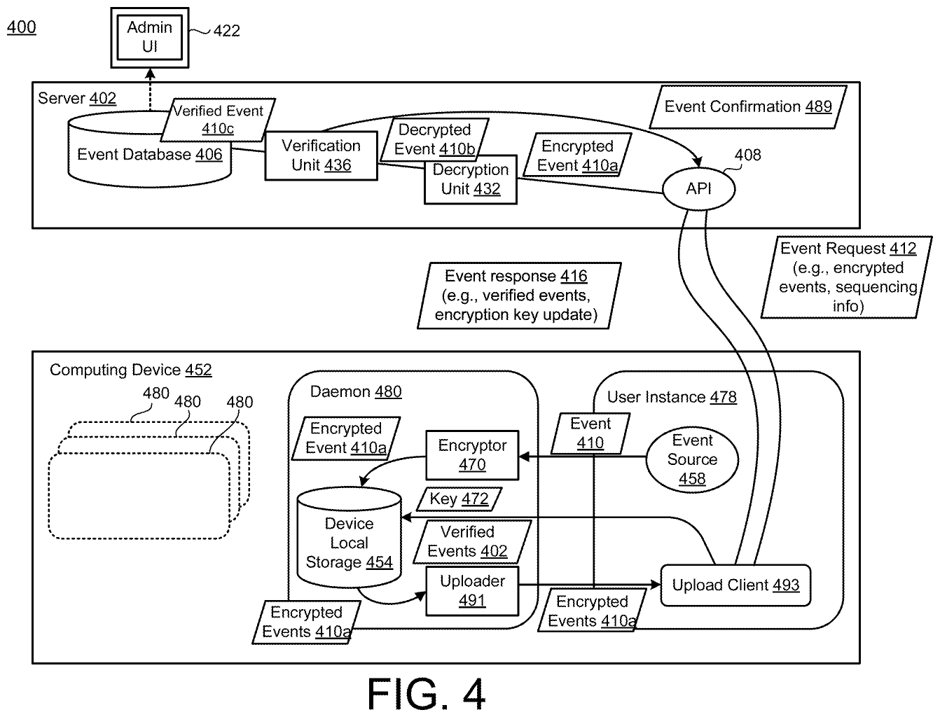

FIG. 4 illustrates a management system 400 having a server 402 and a computing device 452. The management system 400 may be an example of the management system 100 of FIGS. 1A through 1G and may include any of the details discussed with reference to those figures.

The computing device 452 may include a user instance 478 and one or more daemons 480. A user instance 478 may be a portion of an operating system that executes under a user credential of the user. A daemon 480 is a computer program that runs as a background process, rather than being under the direct control of an interactive user (e.g., not launched by the user). For example, the daemon 480 may be a computer program that executes under a system credential. The daemon 480 includes an encryptor 470 that encrypts events 410, using an encryption key 472, received from an event source 458. In some examples, the event source 458 is a portion of the user instance 478. In some examples, the encryptor 470 also receives events 410 from one or more other daemons 480. The encryptor 470 encrypts the events 410 and stores the encrypted events 410a in a device local storage 454. The daemon 480 includes an uploader 491 that selects one or more encrypted events from the device local storage 454 and transmits the encrypted events 410a to an upload client 493. The upload client 493 may be included as part of the user instance 478. The upload client 493 may generate sequencing information (e.g., the sequencing information 114 of FIGS. 1A through 1G) and transmit an event request 412 to the server 402, where the event request 412 includes the encrypted events 410a and the sequencing information. In some examples, the upload client 493 does not generate sequencing information for one or more events 410 or categories of events 410. In some examples, sequencing information is used for one or more types of events 410 but not used for one or more other types of events 410. In some examples, the sequencing information may not be used for low priority events.

An API 408 of the server 402 may receive the event request 412. The server 402 includes a decryption unit 432 configured to decrypt the encrypted event 410a to obtain a decrypted event 410b. The server 402 includes a verification unit 436 configured to whether the event 410 is verified using the sequencing information. In some examples, the verification unit 436 may verify the event 410 in response to the event 110 being successfully decrypted. If the event 410 is verified, a verified event 410c is stored in an event database 406 at the server 402. The verified events 410c can be provided over a network to a computing device 422 associated with an administrator. Also, in response to the event 410 being verified, the verification unit 436 sends an event confirmation 489 to the API 408. The API 408 generates and sends an event response 416 that identifies the verified event 410c. In some examples, the event response 416 may include an encryption key update. The upload client 493 may receive the event response 416. The upload client 493 may provide the identification of the verified events 410c to the daemon 480, where the daemon 480 may remove those events 410 from the device local storage 454.

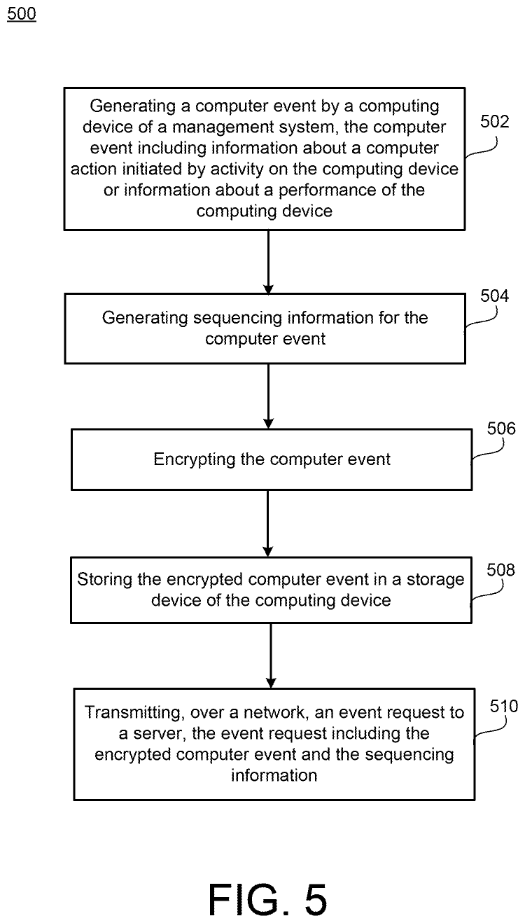

FIG. 5 is a flowchart 500 depicting example operations of a computing device according to an aspect. Although the flowchart 500 is explained with respect to the management system 100 of FIGS. 1A through 1G, the flowchart 500 may be applicable to any of the embodiments discussed herein. Although the flowchart 500 of FIG. 5 illustrates the operations in sequential order, it will be appreciated that this is merely an example, and that additional or alternative operations may be included. Further, operations of FIG. 5 and related operations may be executed in a different order than that shown, or in a parallel or overlapping fashion. In some examples, the flowchart 500 depicts operations performed at a client event manager 156 of a computing device 152. In some examples, the operations are performed by one or more components of an operating system 160 of the computing device 152. The operations may cause events 110 generated by the computing device 152 to be encrypted, stored in a local storage 154, and transmitted according to a sequencing scheme that reduces or eliminates lost events.

Operation 502 includes generating a computer event (e.g., event 110a) by a computing device 152 of a management system. The computer event includes information about a computer action initiated by activity on the computing device 152 or information about the performance of the computing device 152. In some examples, the activity includes user activity. In some examples, the activity includes operating system activity. Operation 504 includes generating sequencing information 114 for the computer event. In some implementations, this may be assigning a next value in sequencing scheme 188. In some implementations, this may be generating a digest (hash) from the preceding event. In some implementations, each priority (e.g., delivery priority level 176-1) may have its own sequencing scheme 188. In some examples, sequencing information 114 is not generated for one or more types of events 110. Operation 506 includes encrypting the computer event. Operation 508 includes storing the encrypted computer event (e.g., encrypted event 110a) in a storage device (e.g., local storage 154) of the computing device 152. Operation 510 includes transmitting, over a network 150, an event request 112 to a server 102. The event request 112 includes the encrypted computer event and the sequencing information 114. In some examples, the sequencing information 114 is included as part of the encrypted computer event. In some examples, the event request 112 does not include the sequencing information 114.

In some examples, the operations include receiving, over the network 150, an event response 116. The event response 116 may include information that the encrypted event 110a is not verified by the server 102. If the encrypted event 110a is not verified by the server 102, the operations may include transmitting a subsequent event request (e.g., another event request 112) to the server 102, where the subsequent event request includes the encrypted event 110a (e.g., re-sends the encrypted event 110a) and one or more other encrypted events 110a (e.g., previously-transmitted encrypted events 110a) that are still stored in the local storage 154. For example, if an event 110 is verified at the server 102, the client event manager 156 receives an event response 116 that indicates that the event 110 has been verified, which causes the client event manager 156 to delete that event 110 from the local storage 154. However, if the event 110 is not verified at the server 102, the event 110 is not deleted from the local storage 154. As such, if a current event 110 is not verified based on the sequencing information 114, it may mean that one or more previously-transmitted events 110 are missing (e.g., lost, dropped, tampered with, etc.) and those missing events 110 would not be deleted from the local storage 154 (because they would not have been verified). In some examples, the subsequent event request may include any non-deleted events 110 that are stored in the local storage (and, in some examples, the non-deleted events 110 would have the same delivery priority level 176).

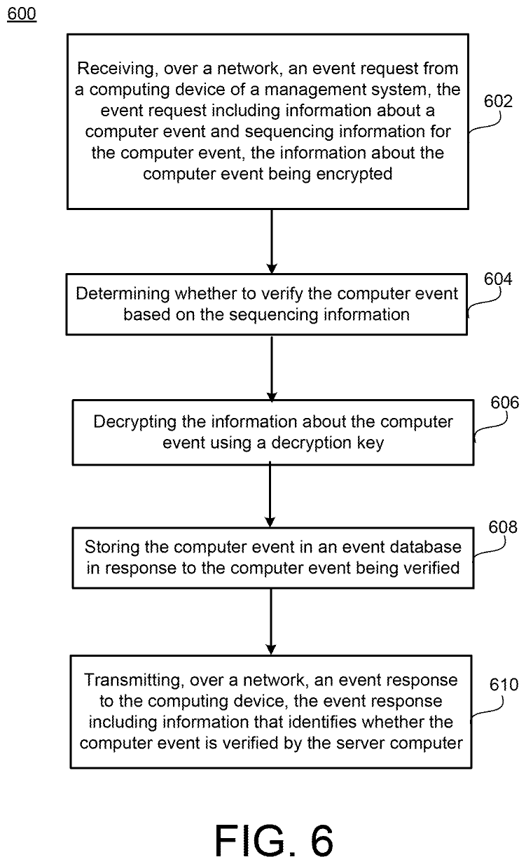

FIG. 6 is a flowchart 600 depicting example operations of a computing device according to an aspect. Although the flowchart 600 is explained with respect to the management system 100 of FIGS. 1A through 1G, the flowchart 600 may be applicable to any of the embodiments discussed herein. Although the flowchart 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion. The operations of FIG. 6 may be executed at a device management unit 104 at a server 102.

Operation 602 includes receiving, over a network 150, an event request 112 from a computing device 152 of a management system 100. The event request 112 includes information about a computer event (e.g., event 110) and sequencing information 114 for the computer event. The information about the computer event is encrypted. Operation 604 includes determining whether to verify the computer event based on the sequencing information 114. An event 110 is verified when the sequencing information 114 for the event 110 aligns with a last verified event 110c. For example, the sequencing information 114 may need to match a next value (e.g., one higher than) the sequencing information 114 of the last verified event 110c. As another example, the sequencing information 114 may need to identify the last verified event 110c. As another example, the sequencing information 114 may need to match a hash (e.g., digest) of the last verified event 110c. In some implementations, the priority (e.g., the delivery priority level 176) of the event 110 is used to determine the last verified event 110c. In some examples, the sequencing information 114 is not used, and the computer event is verified in response to the event 110 being successfully decrypted. Operation 606 includes decrypting the information about the computer event using a decryption key 134. Operation 608 includes storing the computer event in an event database 106 in response to the computer event being verified. Operation 610 includes transmitting, over a network 150, an event response 116 to the computing device 152. The event response 116 includes information that identifies whether the computer event 410 is verified by the server 402.

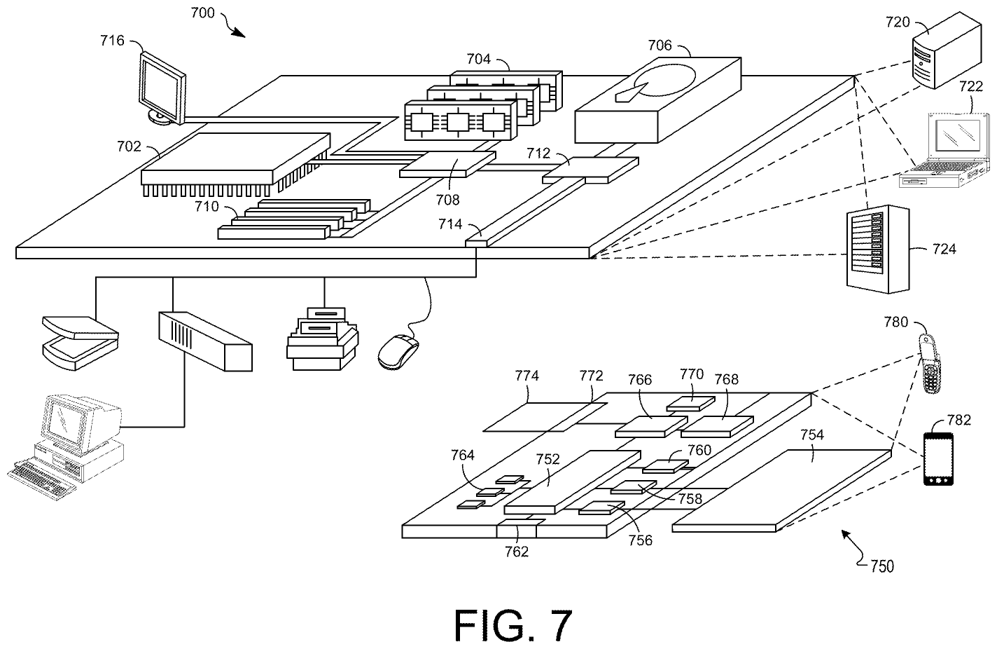

FIG. 7 shows an example of a computing device 700 and a mobile computing device 750, which may be used with the techniques described here. In some implementations, the computing device 152 of FIGS. 1A through 1F is an example of the computing device 700 or the mobile computing device 750. Computing device 700 is intended to represent various forms of digital computers, such as laptops, desktops, tablets, workstations, personal digital assistants, televisions, servers, blade servers, mainframes, and other appropriate computing devices. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. The processor 702 can be a semiconductor-based processor. The memory 704 can be a semiconductor-based memory. Each of the components (e.g., 702, 704, 706, 708, 710, and 712), are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of functions are examples only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more computing devices 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provided in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750 or may also store applications or other information for device 750. Specifically, expansion memory 774 may include instructions to carry out or supplement the processes described above and may include secure information also. Thus, for example, expansion memory 774 may be provided as a security module for device 750 and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or another similar mobile device.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the embodiments disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

What is claimed is:

1. A method comprising:
generating a computer event by a computing device of a management system, the computer event including information about a computer action initiated by activity on the computing device or information about a performance of the computing device;
generating sequencing information for the computer event;
encrypting the computer event to create an encrypted computer event;
storing the encrypted computer event in a storage device of the computing device; and
transmitting, over a network, an event request to a server, the event request including the encrypted computer event and the sequencing information.

2. The method of claim 1, further comprising:
receiving, over the network, an event response from the server, the event response including information that identifies whether the encrypted computer event is verified by the server.

3. The method of claim 2, further comprising:
in response to the encrypted computer event being verified by the server, deleting the encrypted computer event from the storage device.

4. The method of claim 1, wherein the sequencing information is configured to be used by the server to determine whether a previously-sent encrypted computer event has been verified at the server.

5. The method of claim 1, wherein the sequencing information includes a value representing a position of the encrypted computer event in a sequencing scheme.

6. The method of claim 5, wherein the sequencing scheme is specific to the computing device.

7. The method of claim 5, wherein the sequencing scheme is common to two or more computing devices.

8. The method of claim 5, wherein the sequencing scheme is specific to a delivery priority level assigned to the computer event.

9. The method of claim 1, further comprising:
receiving, over the network, an event response from the server, the event response including information that indicates that the encrypted computer event is not verified by the server; and
transmitting a subsequent event request to the server, the subsequent event request including the encrypted computer event and a previously-transmitted encrypted computer event that is stored in the storage device.

10. The method of claim 1, further comprising:
determining a delivery priority level based on a type of the encrypted computer event;
in response to the delivery priority level being determined as a first delivery priority level, delaying transmission of the encrypted computer event for a period of time; and
in response to the delivery priority level being determined as a second delivery priority level, transmitting the encrypted computer event without delaying the transmission for the period of time.

11. An apparatus comprising:
at least one processor; and
a non-transitory computer-readable medium storing executable instructions that when executed by the at least one processor causes the at least one processor to:
generate a computer event by a computing device of a management system, the computer event including information about a computer action initiated by activity on the computing device or information about a performance of the computing device;
encrypt the computer event to create an encrypted computer event;
store the encrypted computer event in a storage device of the computing device;
transmit, over a network, an event request to a server, the event request including the encrypted computer event; and
receive, over the network, an event response from the server, the event response including information that identifies whether the encrypted computer event is verified by the server.

12. The apparatus of claim 11, wherein the computer event is encrypted using an encryption key, and wherein the event response includes an update to the encryption key.

13. The apparatus of claim 11, wherein the encrypted computer event is configured to be decrypted using a decryption key, the decryption key not being stored on the computing device.

14. The apparatus of claim 11, wherein the encrypted computer event is a first encrypted computer event and the event request includes the first encrypted computer event and a second encrypted computer event.

15. The apparatus of claim 11, wherein the executable instructions include instructions that when executed by the at least one processor cause the at least one processor to:
generate sequencing information for the computer event, wherein the event request also includes the sequencing information.

16. The apparatus of claim 11, wherein the executable instructions include instructions that when executed by the at least one processor cause the at least one processor to:
in response to the encrypted computer event being verified by the server, delete the encrypted computer event from the storage device.

17. The apparatus of claim 11, wherein the executable instructions include instructions that when executed by the at least one processor cause the at least one processor to:
in response to the encrypted computer event not being verified by the server, re-transmit the encrypted computer event in a subsequent event request, the subsequent event request also including a previously-transmitted encrypted computer event that is stored in the storage device.

18. A non-transitory computer-readable medium storing executable instructions that when executed by at least one processor cause the at least one processor to execute operations, the operations comprising:
receiving, over a network, an event request from a computing device of a management system, the event request including information about a computer event and sequencing information for the computer event, the information about the computer event being encrypted;
determining whether the computer event is verified based on the sequencing information;
decrypting the information about the computer event using a decryption key; and
transmitting, over the network, an event response to the computing device, the event response including information that identifies whether the computer event is verified.

19. The non-transitory computer-readable medium of claim 18, wherein the computing device is a first computing device and the operations further comprise:
storing, in response to the computer event being verified, the computer event in an event database; and
transmitting, over the network, information to render the computer event on a second computing device associated with an administrator of an organization that manages the first computing device.

20. The non-transitory computer-readable medium of claim 19, wherein the sequencing information includes a value representing a previously-transmitted computer event, the determining including:
determining that the previously-transmitted computer event is stored in the event database; and
in response to the previously-transmitted computer event being determined as stored in the event database, determining that the computer event is a next event in a sequencing scheme.

21. The non-transitory computer-readable medium of claim 18, wherein the sequencing information includes a value representing a position of the computer event in a sequencing scheme, the determining including:
determining that the value is a next value from a value of a last verified computer event.

22. The non-transitory computer-readable medium of claim 20, wherein the determining includes:
determining that the sequencing information corresponds to a hash of a last verified computer event.

23. The non-transitory computer-readable medium of claim 18, wherein the event response includes information that identifies an update to an encryption key used to encrypt a future computer event.
